(19) United States
(12) Patent Application Publication
(10) Pub. No.: US 2016/0077589 A1
(43) Pub. Date: Mar. 17, 2016

(54) MULTIDIMENSION VIBRATING MOUSE

(71) Applicant: E-CONCEPT, La Ravoire (FR)

(72) Inventors: Lionel Chataignier, Montmelian (FR); Geoffrey Chataignier, Montmelian (FR)

(73) Assignee: E-CONCEPT, La Ravoire (FR)

(21) Appl. No.: 14/555,884

(22) Filed: Nov. 28, 2014

(30) Foreign Application Priority Data
Sep. 16, 2014 (FR) 1458757

(51) Int. Cl. G06F 3/01; G06F 3/0354

(52) U.S. Cl. CPC G06F 3/016; G06F 3/03543; G06F 2203/014

(57) ABSTRACT

Mouse capable of communicating with a software application of a computer, comprising a baseplate (2) and a housing (3) linked to one another by a link element (6) allowing the housing (3) to be inclined relative to the baseplate (2), such that the mouse is provided with at least four degrees of freedom, characterized in that the mouse comprises at least one vibration device.

The invention relates to a mouse such as a mouse with six axes making it possible to drive a three-dimensional software application and, more generally, a pointer making it possible to drive such an application.

Such a mouse with six axes is described in the patent documents FR2858072 and FR2881238. It comprises a baseplate bearing a housing to form an assembly that can move in translation in a plane along two horizontal axes at right angles, like the so-called two-dimensional standard mice. However, the housing of such a mouse can move relative to the baseplate, so as to be able to be inclined by rotating about a horizontal longitudinal axis, and by rotating about a horizontal transverse axis, which constitutes two additional axes. This mouse is intended for the manipulation of three-dimensional digital virtual objects, displayed by a software application, such as a computer-assisted design application. It can thus drive the application in such a way as to couple the movements of a three-dimensional object displayed by the application on the computer screen with the actual movements of the housing of the mouse. The movements that the user imposes on the housing of the mouse and the actuation of a thumbwheel borne by the housing are then reflected in corresponding movements of the object that is being manipulated. It can also be used to move around in a digital three-dimensional space. The actual movements of the housing are then reflected in movements and modifications of the orientation of the point of view from which this three-dimensional space is displayed by the application.

Such a mouse is advantageous in that it allows for a wider variety of uses than a simple two-dimensional traditional mouse. However, it remains inadequate for certain applications, like in the video gaming field.

The object of the present invention is to provide an enhanced mouse for interacting with a software application, notably a video game.

To this end, the invention is based on a mouse capable of communicating with a software application of a computer, comprising a baseplate and a housing linked to one another by a link element allowing the housing to be inclined relative to the baseplate, such that the mouse is provided with at least four degrees of freedom, characterized in that the mouse comprises at least one vibration device.

The mouse can comprise at least two vibration devices arranged in different parts of the mouse, notably at the front and at the rear or on the right and on the left.

At least one vibration device of the mouse can be fixed to the housing and/or to a printed circuit inside the mouse, notably in proximity to the housing.

The mouse can comprise at least one lighting device, notably one or more LEDs.

The housing of the mouse can bear at least one accelerometer and the baseplate can bear at least one other accelerometer, the measurements of these accelerometers being used to deduce therefrom the inclination of the housing.

The invention relates also to a computing device comprising a computer and a screen, characterised in that it comprises a mouse as defined previously.

The invention relates also to a method implemented by a software application on a computer of a computing device, characterized in that it comprises the following steps:
reception of commands for movements in space via the movement of a mouse provided with at least four degrees of freedom;
feedback of information by triggering the vibration of a vibration device in the mouse.

The information can be of spatial nature, notably linked to an area of a screen connected to the computer.

The method can comprise the following steps:
Display of information on a first area of a screen and triggering of the vibration of a first vibration device of the mouse;
Display of other information on a second area of a screen and triggering of the vibration of a second vibration device of the mouse.

The method can comprise a step of lighting one or more blinking or non-blinking lighting devices of the mouse as a function of a parameter of the software application.

These objects, features and advantages of the present invention will be explained in detail in the following description of a particular embodiment given as a non-limiting example in relation to the attached figures, in which:

FIG. 1 is a perspective overview from above of a mouse according to one embodiment of the invention.

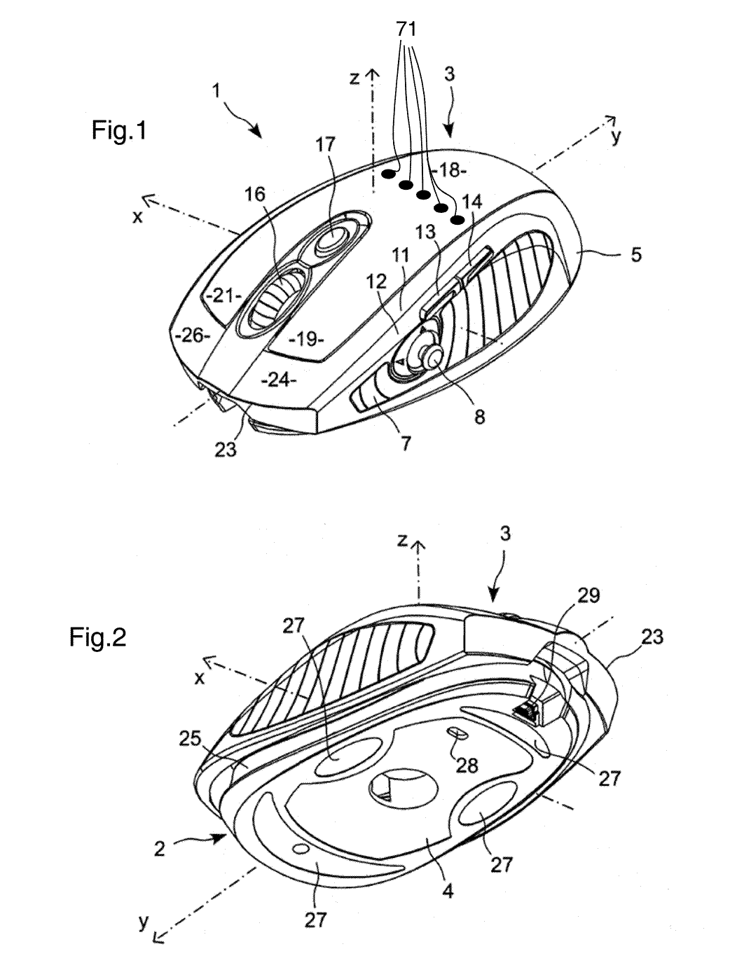

FIG. 2 is an overview in perspective from below of the mouse according to the embodiment of the invention.

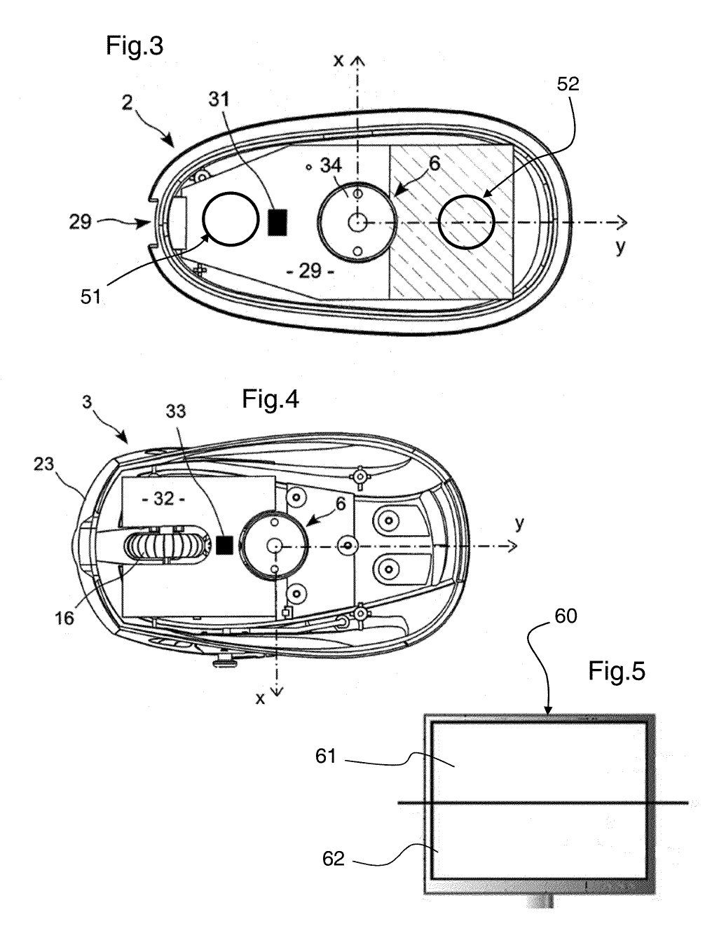

FIG. 3 is a view showing only the baseplate of the mouse with its electronic card according to the embodiment of the invention.

FIG. 4 is a view showing only the housing of the mouse with its electronic card according to the embodiment of the invention.

FIG. 5 represents a screen coupled to the mouse according to the embodiment of the invention.

The mouse according to one embodiment of the invention can incorporate a structure as described by the document FR2953609, the content of which is incorporated herein by reference. As can be seen in FIGS. 1 and 2, the mouse 1 comprises a baseplate 2 bearing a housing 3 which has a generally domed shape favouring grasping by the user. The baseplate 2 comprises a planar bottom face 4 via which it bears on a horizontal plane, such as a table or a mouse mat, identified by the two horizontal axes x and y at right angles. The mouse 1 can therefore move in translation over this horizontal plane along the two horizontal axes x and y at right angles. It can also move in rotation about an axis normal to this plane, namely the yaw axis z. For its part, the housing can be inclined by a roll movement relative to the baseplate by pivoting about the horizontal transverse axis x, and it can be inclined by a pitch movement by pivoting about the horizontal longitudinal axis y.

The housing 3 of the mouse 1 is linked to the baseplate 2 by a link element 6 that can be seen in particular in FIG. 3, and which is, here, a solid piece of rubber or similar that has a general outer shape said to be like a bobbin or even biconical. This link element 6 or bobbin extends in the vertical direction z and comprises a bottom end by which it is rigidly secured to the baseplate 2, and a top end by which it is rigidly secured to the top housing 3. This bobbin 6 is manufactured in an elastic material such as rubber or similar to allow the housing 3 to pivot relative to the baseplate 2 about two axes x and y at right angles to one another and parallel to the bottom face 4. In the representation given in the figures, the axes x, y and z form the axes of an indirect orthogonal reference frame, each passing through the centre of symmetry C of the bobbin 6. It should be noted that the link between the baseplate and the housing prohibits a movement of the housing vertically relative to the baseplate, as well as a rotational movement about the axis z of the housing relative to the baseplate. The rotation of the housing 3 relative to the baseplate 2 about the axis z is prohibited in particular by the fact that the baseplate 2 and the housing 3 have shapes which fit partially into one another when the unit is assembled, with a certain play along the axes x and y, which enables the housing to be inclined while preventing it from pivoting relative to the baseplate about the axis z.

Generally, the housing 3 comprises a housing body identified by 5 and bearing a set of actuators and a so-called top electronic card, which is rigidly secured to this housing body. The housing body 3 comprises a left lateral flank 7, on which bears the thumb of a user gripping the mouse, and this left lateral flank 7 bears a joystick 8, situated partly forward and extending in a direction substantially parallel to the axis x, so as to be able to be manipulated by the thumb of the user. This housing body 5 also comprises a domed top face 11, which delimits, jointly with the flank 7, a blunt edge 12 bearing two pushbuttons 13 and 14 situated substantially at mid-length along the left flank 7, and these can also be actuated by the thumb of the user. The top front part of the housing body bears, on the one hand, a rotary thumbwheel 16 that can be manipulated by the middle finger of the user holding the mouse, and an additional pushbutton 17 situated above the thumbwheel 16 and that the user can also actuate with his or her middle finger.

The domed top face 11 of the housing body 5 is covered by a domed and flexible additional plate 18, the front part of which has two branches 19 and 21 situated on either side of the thumbwheel 16 and of the pushbutton 17. These two branches 19 and 21 respectively constitute a so-called left click button and a so-called right click button that can be actuated respectively by the index finger and by the middle finger of a right-handed user holding the mouse. As can be seen in FIG. 1, the two buttons 19 and 21 are spaced apart from the front end of the housing body 5 which is here embodied in particular by a front edge 23 that has a transversley-oriented curved shape. The edge 23 is thus separated longitudinally from each of these buttons 21 and 22 respectively by two bearing areas identified by 24 and 26, these bearing areas forming an integral part of the front of the housing body 5. The fact that the left and right click buttons are separated from the front end of the housing by two bearing areas 24 and 26 enables the user to incline the housing in roll mode by directly exerting forces on these bearing areas 24 and 26, that is to say with no risk of inadvertently clicking. With regard to the baseplate 2, this, also, comprises a baseplate body 25 bearing a so-called bottom printed circuit board and different components. As can be seen notably in FIG. 2, the bottom face 4 of this baseplate body is equipped with a set of skids 27 making it easier to slide. It is moreover equipped with a movement sensor of laser type, identified by 28, and by virtue of which the translational movements along the axes x and y relative to the support are measured. Moreover, this baseplate 2 comprises, in its front part, a connector of mini-USB type, by virtue of which the mouse can be linked to a computer so as to transmit its information, and/or to recharge a battery incorporated in this mouse to enable it to exchange information with the computer via a wireless link.

As can be seen in FIG. 3, the baseplate 2 bears a so-called bottom printed circuit which is identified by 29, which is rigidly secured to this baseplate by means that are not represented, and which itself bears different components including a so-called bottom accelerator identified by 31 rigidly secured to this printed circuit. This bottom printed circuit also bears components specific to the mini-USB connector, to the laser sensor 28, and to other components. Similarly, and as represented in FIG. 4, the housing 3 bears another printed circuit, called top printed circuit, and identified by 32, which is rigidly secured to the housing body 5. This top printed circuit bears a so-called top accelerator identified by 33, also rigidly secured to the printed circuit which bears it, and a set of components such as the clicking wheel 16, the joystick 8 and the switch of the pushbutton 17. These two printed circuits are electrically linked to one another by a connector which is not represented, in such a way that the information from the top printed circuit, such as the depressed state of one or other of the left and right clicks, the position of the wheel 16 or even the position of the joystick 8 is transmitted to the bottom printed circuit 29.

The two accelerometers 31 and 33 are used jointly by a computation unit that is not represented, as such as a microcontroller, with which the bottom printed circuit is for example equipped, to determine the inclination of the housing 3 relative to the baseplate 2.

The two accelerometers are advantageously identical electronic components so as to simplify the processing of the signals that they deliver. They are advantageously accelerometers in the form of MEMS electronic components of LIS331 DLH type marketed under the brand name ST. Each accelerometer supplies signals representative of the accelerations that it undergoes along three orthogonal axes that are specific to it, and these signals are addressed to the microcontroller with which the bottom printed circuit 31 is equipped. The signals from the accelerometers 31 and 33 are processed by the microcontroller to determine the inclination of the housing 3 relative to the baseplate 2, on the one hand about the axis x and on the other hand about the axis y. To this end, the microcontroller recovers, at each instant, the signals representative of the acceleration undergone by the top accelerometer and by the bottom accelerometer along the axis x.

Also, the mouse 1 is equipped with two vibration devices 51, 52, respectively positioned in the front and rear parts of the mouse 1, as schematically represented in FIG. 3, the front and rear positionings extending in the opposite direction from the direction y, and corresponding substantially to the direction of the hand of the operator placed on the mouse. Each vibration device 51, 52 comprises a motor and an electrical connection to link it to one of the printed circuits of the mouse for its electrical power supply and its communication with the software application, the motor being able to be physically fixed to the housing 3 and/or to one of the printed circuits of the mouse. Advantageously, the motor generating the vibration is fixed to one of the printed circuits in the mouse, while being located in proximity to the housing to favour the perception of the vibration by the hand placed on the outside on the mouse.

The operation of these two vibration devices 51, 52 is coupled to a software application of the computer to which the mouse is linked, so that each vibration is triggered to transmit particular information to the operator of the mouse, dependent on how the software runs. In particular, each vibration can be linked to a spatial information item defined by the software, to improve the understanding of the three-dimensional information that a software application can present to an operator on a screen.

As an illustrative example, FIG. 5 represents a screen 60 on which a software application displays two complementary information items, respectively in the top 61 and bottom 62 parts of the screen, which is thus divided into two display areas. Notably, the software application can consist of a video game, which presents, in the top part 61, a character seen face-on or, more generally, a landscape from a first view, called front view, and, in the bottom part 52, the same character seen from the back or the same landscape seen from an opposite direction, called rear view. Upon a game event originating from the front relative to the definition chosen above, more particularly visible in the top part 61 of the screen, the software application can trigger a vibration of the mouse 1 by the front vibration device 51. Similarly, upon a game event originating from the rear, more particularly visible in the bottom part 62 of the screen, the software application can trigger a vibration of the mouse 1 by the rear vibration device 52. Thus, the vibration device transmits feedback information to a gamer concerning a game event, and draws his or her attention to a certain space of the game, and at the same time an associated area of the screen 60.

Naturally, the above approach could also be based on two vibration devices distributed differently in the internal volume of the mouse, for example on the left and on the right, or at the top and at the bottom. Furthermore, there could be more than two motors, notably three or four. According to a simplified version, a single vibration device could be used, but this would no longer make it possible to differentiate different information of a spatial nature.

According to another embodiment, advantageously combined with the preceding embodiment, the mouse comprises a plurality of lighting devices 71, advantageously in the form of LEDs arranged in openings of the top surface of the housing 3, as represented in FIG. 1, and electrically linked to at least one of the printed circuits of the mouse 1. As previously, these lighting devices can operate in a manner controlled by a software application, in order to visually inform an operator of certain parameters of the software application, in addition to or instead of the information transmitted by a screen 60. Notably, in the case of the video game, these lighting devices can inform a gamer as to a level of life of a character of the game, a level of danger, etc. As a variant, the lighting information can multiply the transmitted information by colours blinking at different frequencies.

The invention is not limited to the mouse described in the above description, but can be applied to any mouse provided with a multitude of possible movements to allow for spatial information exceeding two dimensions, while remaining linked to a plane to allow it to be grasped painlessly in a user-friendly and sustainable manner by an operator. Notably, the mouse is advantageously provided with translational movements in two directions, and a plurality of rotational movements, notably about the axes x and y and/or z, therefore according to at least four degrees of freedom, for example five. As a variant, a thumbwheel can be used to add a degree of freedom, to reach, for example, the six degrees of freedom that allow all movements in space. Advantageously, the mouse is wireless.

The invention relates also to a method implemented by a software application using a mouse according to the invention, which can comprise the following steps:
reception of commands for movements in space via a mouse provided with at least four degrees of freedom;
feedback of information by triggering the vibration of a vibration device in the mouse.

This information can be of a spatial nature, enabling the user of the mouse to deduce therefrom a position or a movement linked to an event generated by the software application.

The method can also comprise the following steps:
display of information on a first area of a screen and triggering of the vibration of a first vibration device of the mouse;
display of information on a second area of a screen and triggering of the vibration of a second vibration device of the mouse.

In addition, the method can comprise the lighting of one or more blinking or non-blinking lighting devices of the mouse.

1. Mouse capable of communicating with a software application of a computer, comprising a baseplate a housing linked to one another by a link element allowing the housing to be inclined relative to the baseplate, such that the mouse is provided with at least four degrees of freedom, wherein the mouse comprises at least one vibration device.

2. Mouse according to claim 1, wherein it comprises at least two vibration devices arranged in different parts of the mouse, notably at the front and at the rear or on the right and on the left.

3. Mouse according to claim 1, wherein a vibration device of the mouse is fixed to the housing and/or to a printed circuit inside the mouse, notably in proximity to the housing.

4. Mouse according to claim 1, wherein it comprises at least one lighting device, notably one or more LEDs.

5. Mouse according to claim 1, wherein the housing bears at least one accelerometer and wherein the baseplate bears at least one other accelerometer, the measurements of these accelerometers being used to deduce therefrom the inclination of the housing.

6. Computing device comprising a computer and a screen, wherein it comprises a mouse according to claim 1.

7. Method implemented by a software application on a computer of a computing device according to claim 6, wherein it comprises the following steps:
reception of commands for movements in space via the movement of a mouse provided with at least four degrees of freedom;
feedback of information by triggering the vibration of a vibration device in the mouse.

8. Method according to claim 7, wherein the feedback is of spatial nature, notably linked to an area of the screen connected to the computer.

9. Method according to claim 7, wherein it comprises the following steps:
Display of information on a first area of a screen and triggering of the vibration of a first vibration device of the mouse;
Display of other information on a second area of a screen and triggering of the vibration of a second vibration device of the mouse.

10. Method according to claims 7, wherein it comprises a step of lighting one or more blinking or non-blinking lighting devices of the mouse, as a function of a parameter of the software application.
